(19) United States
(12) Patent Application Publication
(10) Pub. No.: US 2003/0130892 A1
(43) Pub. Date: Jul. 10, 2003

(54) Frequent customer points management method and system

(75) Inventors: Masashi Taono, Tokyo (JP); Shingo Ikki, Fujisawa (JP); Nobuyuki Honma, Yokohama (JP); Mari Nakazato, Tokyo (JP); Kiyotaka Matsumoto, Saitama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/152,539

(22) Filed: May 20, 2002

(30) Foreign Application Priority Data
Jan. 7, 2002 (JP) 2002-000700

(51) Int. Cl. G06F 17/60

(52) U.S. Cl. 705/14; 705/34

(57) ABSTRACT

A frequent customer point management method for giving frequent customer points corresponding to use of goods from a goods provider to customers inclusive of purchasers and users of goods, using a point management system including at least a bill payer information storage portion for storing information of a payer of a bill of goods and a point information storage portion for storing information of application of a point corresponding to the goods. Bill payer information stipulating a payer of a bill of the goods is received from the customer, the bill payer information storage portion is retrieved on the basis of the bill payer information so received, and the point information storage portion is updated to stipulate the bill payer as the point acquiring party corresponding to the goods when the bill payer is found registered to the bill payer information storage portion.

### BACKGROUND OF THE INVENTION

This invention relates to a frequent customer points management method and its system.

To improve services for customers purchasing greater amounts of goods, systems issuing mileage cards, point cards (magnetic cards, etc), and so forth, that add a benefit point (hereinafter merely called the “point”) corresponding to the purchase amount whenever a customer purchase goods are known. These systems manage the points and give coupons, etc, to clients acquiring the sum of points exceeding stipulated points. These systems are directed to further heighten customers' motivations and to secure frequent customers who are expected to consecutively purchase.

When employees of companies utilize traffic facilities and the like on business trips or events, the companies naturally bear the expenses.

Although the employers bear the expenses, however, the points of goods or services have been given to the employees whose utilize them. When the employee utilizes an airline on business trip, for example, the mileage points of a mileage service offered in accordance with a flying distance is given to the employee who actually utilizes the airline.

Therefore, a part of the expenses of the company as the employer is donated in a sense to the employee, and the pay the employee receives from the company differs depending on the number of business trips, for example.

### SUMMARY OF THE INVENTION

With the background described above, this invention aims at providing a technology for stipulating a point acquiring party of points of goods or services to a payer of a bill.

A frequent customer point management method according to the invention uses an information processing system including bill payer information storage means for storing information of a payer of a bill of goods and point information storage means for storing information of application of points corresponding to the goods. Bill payer information for stipulating the payer of the bill of the goods is received and the bill payer information storage means is retrieved on the basis of the bill payer information so received. When the bill payer is found registered to the bill payer information storage means, the points information storage means is updated while the bill payer is stipulated as the acquiring party of the points corresponding to the goods.

The term “goods” used herein includes services or in other words, all the purchase objects corresponding to the money paid.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a hardware construction for giving points in point management according to an embodiment of the invention;

FIGS. 2A, 2B, 2C and 2D are tables each showing a concrete example of a file structure of a database 140 of an apparatus 100 on the side of a goods provider in point management according to the embodiment of the invention;

FIGS. 3A, 3B, 3C and 3D are tables each showing a concrete example of a file structure of the database 140 of the apparatus 100 on the side of the goods provider in point management according to the embodiment of the invention;

FIGS. 4A, 4B, 4C and 4D are conceptual views each showing good purchase and bill payment procedures between a goods purchaser or a goods user and the good provider in point management according to the embodiment of the invention;

FIGS. 5A, 5B and 5C are flowcharts each showing briefly a process of each system when only the goods purchaser is registered to the database 140 of the apparatus 100 in point management according to the embodiment of the invention;

FIG. 6A is a schematic view of a screen displayed on a terminal while FIG. 6B shows a screen for inputting and displaying a utilization record of goods in point management according to the embodiment of the invention;

FIG. 7 is a flowchart showing briefly a process of a goods purchasing process in a system A when only the goods purchaser is registered to the database 140 of the apparatus 100 in point management according to the embodiment of the invention;

FIG. 8 is a flowchart showing a goods purchasing process in systems C and D when only the goods purchaser is registered to the database 140 of the apparatus 100 in point management according to the embodiment of the invention;

FIGS. 9A and 9B are flowcharts each showing briefly a process of each system when both goods purchaser and goods user are registered to the database 140 of the apparatus 100 in point management according to the embodiment of the invention; and

FIG. 10 is a flowchart showing a goods purchasing process in systems B and D when both goods purchaser and goods user are registered to the database 140 of the apparatus 100 in point management according to the embodiment of the invention.

### DESCRIPTION OF THE EMBODIMENTS

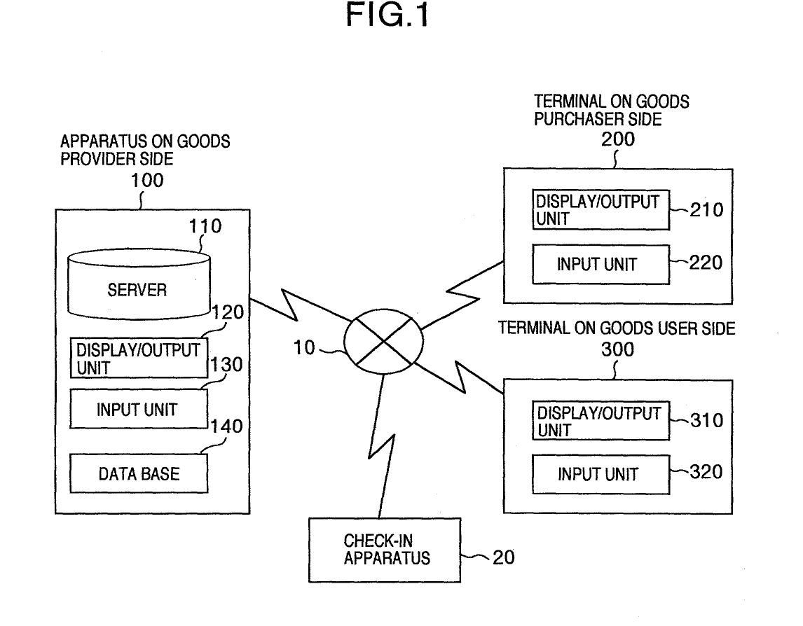

An embodiment of the invention will be hereinafter explained with reference to FIGS. 1 to 10. First, the outline will be explained. As shown in the block diagram of FIG. 1, a terminal 200 of a goods purchaser (user), a terminal 300 of a goods user (user) and a check-in terminal 20 gain access (are connected) to an apparatus (information processing system) 100 of a goods provider as a points management system through a suitable communication network such as the Internet 10. The apparatus 100 on the goods provider side includes a server main body 110 having a database 140 and a display/output unit 120 and an input unit 130 that are connected to the server main body 110. The database (bill payer information storage means and points information storage means) 140 stores data files of the purchase of goods and points in an appropriate form as will be later described. Each terminal 200, 300 has a display/output unit 210, 310 and an input unit 220, 320 and is constituted by a personal computer having a browsing function. The terminal 200, 300 may use a PDA (Personal Digital Assistant) or a cellular telephone set each having an information terminal function. Each display/output unit 120, 210, 310 uses a display or a printer, and each input unit 130, 220, 320 uses a keyboard or a mouse.

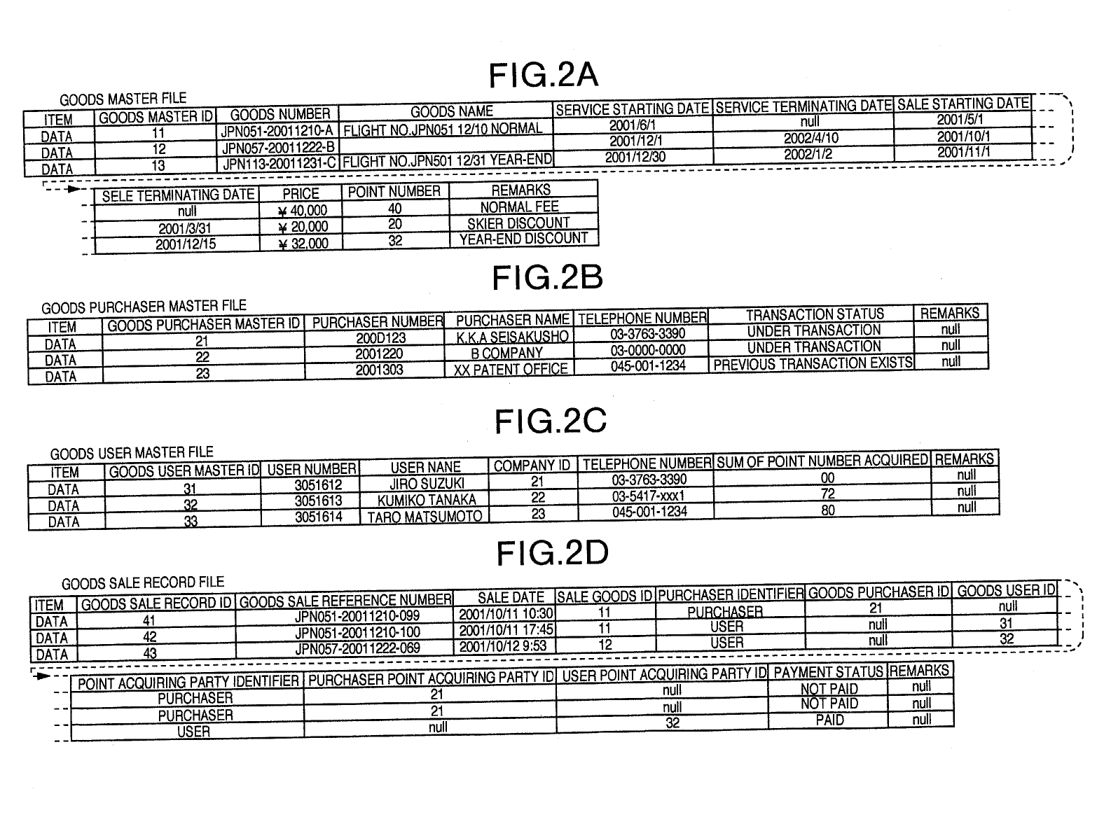

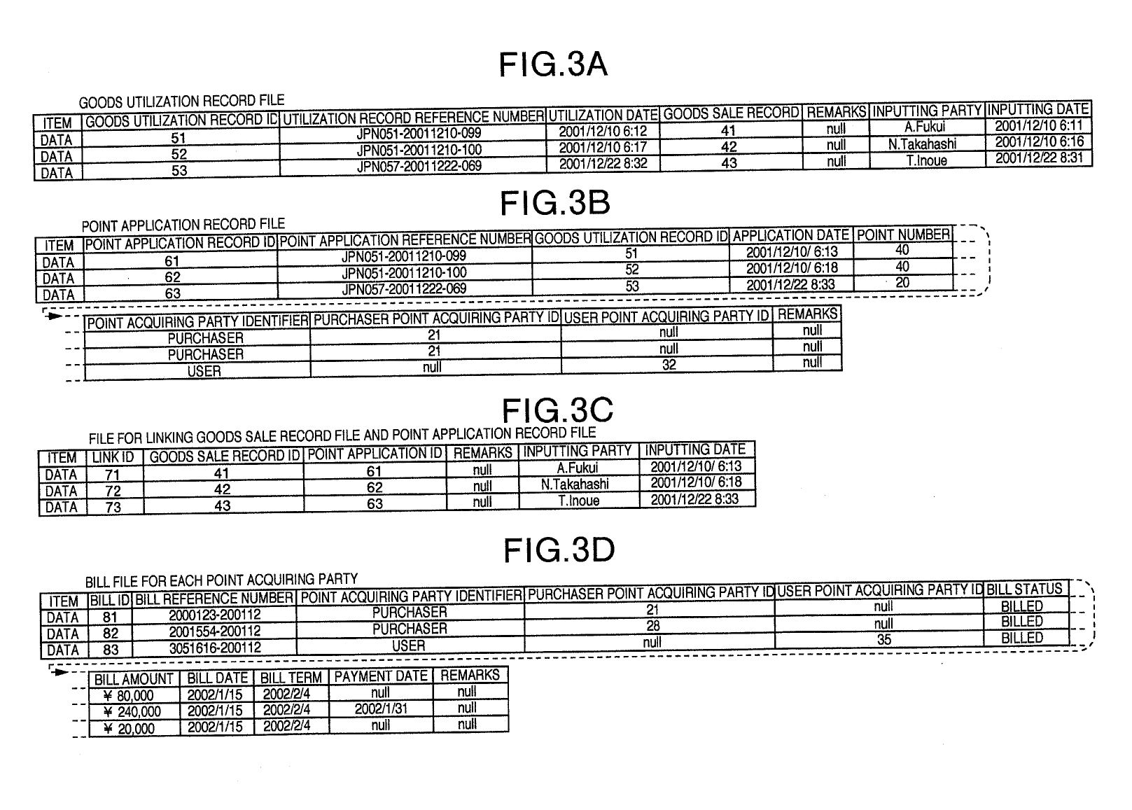

An example of the file structure of the database 140 of the apparatus 100 on the goods provider side will be explained. The file structure includes a goods master file, a goods purchaser master file, a goods user master file and a goods sale record file that are respectively shown in FIGS. 2A to 2D, and a goods utilization record file, a point application record file, a file for associating (linking) the goods sale record file with the point application record file and a billing file for each point acquiring party that are respectively shown in FIGS. 3A to 3D.

Next, a structural example of each file will be explained. As shown in FIG. 2A, the goods master file contains data of goods as a purchase object. The data items include a goods master ID, a goods number, a goods name, a service starting date, a service terminating date, a sale starting date, a sale terminating date, a price, a point number and remarks. The goods master ID is an ID of the corresponding goods. The service starting date is a starting date of the point application service. The service terminating date is a terminating date of the point application service. The sale starting date is a date at which the sale of the goods is started and the sale terminating date is a data at which the sale of the goods is terminated. The point number is the number of points given in accordance with the purchase of the goods. The remarks are information that is appropriately provided to the goods. As to the price, for example, the remarks include “normal fee”, “skier discount”, “year-end special discount”, and so forth.

The goods purchaser master file contains data of the goods purchaser as shown in FIG. 2B. The data items include a goods purchaser master ID, a purchaser number, a purchaser name, a telephone number, a transaction status and remarks. The goods purchaser master ID is an ID of the goods purchaser, and the transaction status represents a status of transactions such as “under transaction” or “record of previous transactions exists”.

The goods user master file contains the data of the goods user as shown in FIG. 2C. The data items include a good user master ID, a user number, a user name, a company ID, a telephone number, a sum of points acquired and remarks. The goods user master ID is an ID of the goods user. The company ID is an ID of the company to which the goods user belongs. The sum of points acquired is the sum of points given to the purchaser with the purchaser of goods.

The goods sale record file contains data of the sale records of goods as shown in FIG. 2D. The data items include a goods sale record ID, a goods sale reference number, a sale date, a sale goods ID, a purchaser identifier, a goods purchaser ID, a goods user ID, a point acquiring party identifier, a purchaser point acquiring party ID, a user point acquiring party ID, a payment status and remarks. The goods sale record ID is an ID for looking up the data of the sale record of the goods. The good sale reference number is the number for looking up the content of the sale of the goods. The sale goods ID is an ID representing the goods sold. The point acquiring party identifier is an identifier representing whether the point acquiring party (bill payer) is the purchaser or the user. The purchaser point acquiring party ID is an ID of the purchaser when the point acquiring party identifier represents the purchaser. The user point acquiring party ID is an ID of the user when the point acquiring party identifier represents the user. The payment status presents whether the bill is “not yet paid” or “paid”.

The goods utilization record file contains the data of the utilization record of goods as shown in FIG. 3A. The data items include a good utilization record ID, a utilization record reference number, a utilization date, a goods sale record ID, remarks, an inputting party and an inputting date. The goods utilization record ID is an ID for looking up the data of the utilization record of goods. The utilization record reference number is the number for looking up the content of the utilization record. The goods sale record ID is an ID for looking up the content of the goods sale. The inputting party represents the name of the party who inputs the data of the goods utilization record file. The inputting date represents the data of inputting of the data.

The point application record file contains data about the point application record. The data items includes a point application record ID, a point application reference number, a goods utilization record ID, an application date, a point number, a point acquiring party identifier, a purchaser point acquiring party ID, a user point acquiring party ID and remarks. The point application record ID is an ID for looking up the data of the point application. The point application reference number is the number for introducing the content of the point application. The goods utilization record ID is an ID for looking up the data of the goods utilization record. The application date represents the date of the application of the points. The point number is the number of points given. The point acquiring party identifier is the identifier representing whether the acquiring party of the point (bill payer) is the purchaser or the user. The purchaser point acquiring party ID is an ID of the purchaser when the point acquiring party identifier represents the purchaser. The user point acquiring party ID is an ID of the user when the point acquiring party identifier represents the user.

The file for linking the goods sale record file and the point application record file contains the data of the items including a link ID, a goods sale record ID, a point application ID, remarks, an inputting party and an inputting date. The link ID is an ID for looking up the data about the link. The goods sale record ID is an ID for looking up the data of the goods sale record. The point application ID is an ID for looking up the data of the point application. The inputting party represents the name of the person who inputs the data of the goods utilization record file. The inputting date represents an inputting date of the data.

The billing file for each point acquiring party contains a plurality of data items as shown in FIG. 3D. The data items includes a bill ID, a bill reference number, a point acquiring party identifier, a purchaser point acquiring party ID, a user point acquiring party ID, a bill status, a bill amount, a bill date, a bill term, a payment date and remarks. The bill ID is an ID for looking up the data of the bill. The bill reference number is the number for looking up the content of the bill. The bill status represents whether billing is “made” or “not yet made”. The bill term is the term for payment.

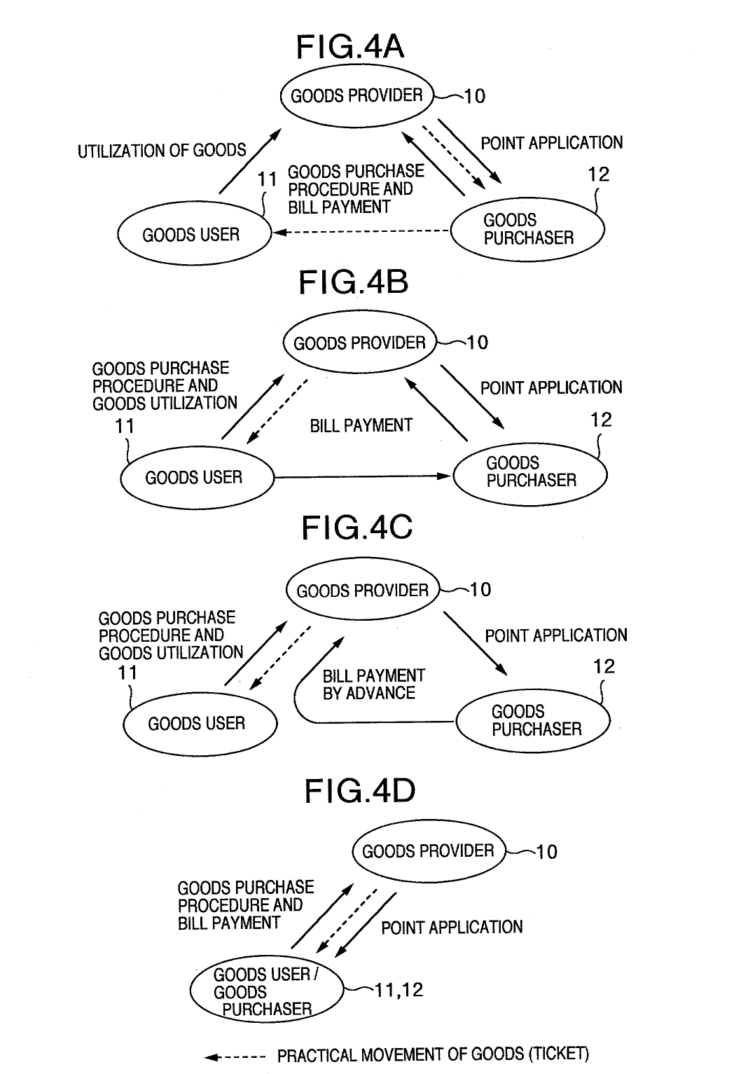

The point management method of this invention gives the point acquired at the time of the purchase or use of the goods to the person who actually pays the money (purchaser of goods) when purchasing the goods but not to the user of the goods. As shown in the conceptual view of FIGS. 4A to 4D, various systems A to D will be conceptually available depending on the difference of a person who is in charge of the purchase of the goods and the payment. In all of these systems A to D, the point is given to the person who finally pays the money (purchaser of goods), and the timing of giving the point is when the use of the goods is acknowledged. Needless to say, the point may be given at the time of purchase of the goods or the payment of the money.

In all the systems A to D, the goods provider 10, the goods user 11 and the goods purchaser 12 basically execute the later-appearing process by using the apparatus 100 and each terminal 200, 300, respectively.

First, in the system A shown in FIG. 4A, the goods purchaser 12 makes by himself the purchase procedure, delivers the goods to the user of the goods and then pays the money. In the system B shown in FIG. 4B, the user of the goods makes the purchase procedure of the goods, acquires the goods and requests the goods purchaser 12 to pay the money. In the system C shown in FIG. 4C, the user of the good makes the purchase procedure of the good, acquires the goods by paying an advance and requests the goods purchaser 12 to settle the advance. In the system D shown in FIG. 4D, the user of the goods is by himself the purchaser, purchases the goods, pays the money, and acquires and uses the goods.

These systems A to D will be explained as a concrete processing of hardware. There are two cases in the database 140 inside the server 110 of the goods provider 10, that is, the case where only the goods purchaser 12 is registered in advance and the case where both goods purchaser 12 and goods user 11 are registered in advance.

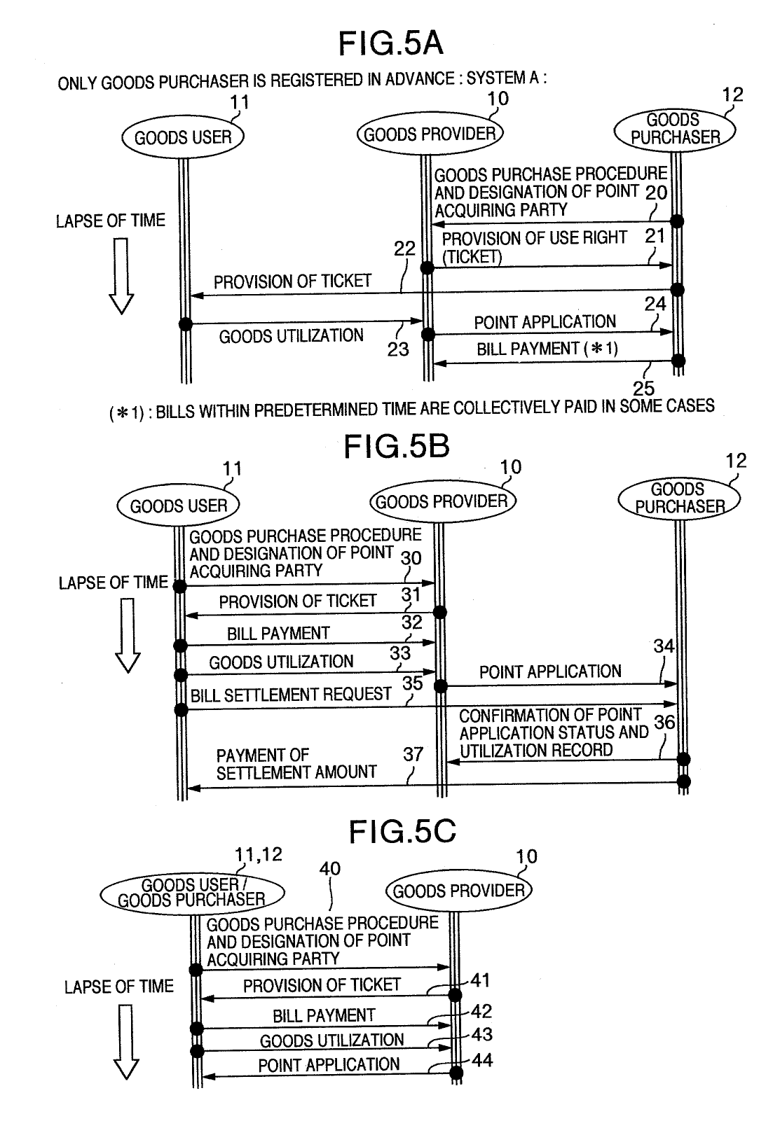

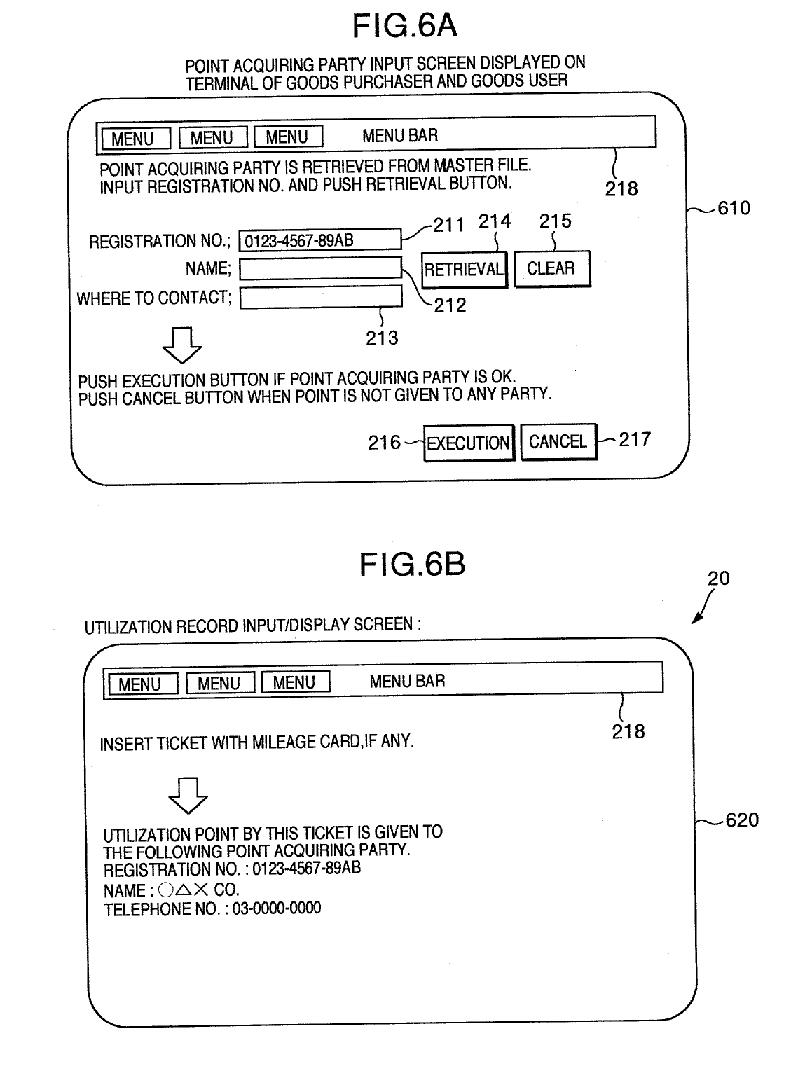

First, the explanation will be given first on the former, that is, the case where only the goods purchaser 12 is in advance registered. In this case, the systems A, C and D are conceivable. The system A will be explained first. Generally speaking, the goods purchaser 12 communicates with the apparatus 100 of the goods provider 10 through the terminal 200, makes the purchase procedure of the goods and gives an instruction of the point acquiring party to the apparatus 100 of the goods provider 10 (Step 20 in FIG. 5A). In this instance, a screen for designating and inputting the point acquiring party is displayed on the display 610 of the display/output unit 210 of the terminal 200 of the goods purchaser 12 as shown in FIG. 6A. This input screen includes a column 211 to which the registration number of the goods purchaser as the bill payer is inputted as the point acquiring party. The goods purchaser 12 inputs the registration number and then clicks an execution button 216 through the mouse to designate and input the point acquiring party. In consequence, an associated file in the database 140 inside the server 110 of the goods provider 10 is updated. The display 610 also displays boxes of menu bar 218, name 212, where to make contact 213, retrieval 214, clear 215 and cancel 217. More concretely, as represented by the goods sale record file in FIG. 2D, a new goods sale record ID is generated to reflect this sale record, the point acquiring party identifier is set to the purchaser and the purchaser point acquiring party ID is set to the purchaser ID. The billing file for each point acquiring party shown in FIG. 3D is updated, and a new billing ID is issued in accordance with the purchaser point acquiring party ID. The bill ID, the bill reference number, the point acquiring party identifier, the purchaser point acquiring party ID, the user point acquiring party ID, the bill status, the bill amount date, the bill term, the payment date and remarks are recorded.

Next, a ticket such as an airline ticket as the goods is provided to the goods purchaser 12 (Step 21). The goods purchaser 12 offers the ticket to the goods user 11 (Step 22). The goods user 11 actually uses the ticket and acquires the point (Step 23→24). In this instance, the associated file in the database 140 inside the server 110 of the goods provider 10 is updated. Concretely, in the goods utilization record file shown in FIG. 3A, the goods utilization record ID is generated, and the utilization record reference number, the utilization date, the goods sale record ID, the remarks, the inputting party and the inputting date are recorded to reflect this utilization record of the goods. A new point application record ID is generated for the point application record file shown in FIG. 3B, too, and the point application reference number, the goods utilization record ID, the application date, the point number, the point acquiring party identifier, the purchaser point acquiring party ID and the remarks are recorded. A new link ID is generated for the file linking the goods sale record file and the point application record file in accordance with the point application record ID, and the predetermined data items such as the sale record ID are recorded appropriately, as shown in FIG. 3C. In this instance, whether or not the goods purchaser 12 is registered is confirmed by retrieving the goods purchaser master file shown in FIG. 2B. When the goods purchaser 12 is found registered, a notice is displayed on the display 620 of the check-in apparatus 20, that is connected to the network 10 and is used when the ticket is utilized as shown in FIG. 6B, to the effect that the point is actually given in accordance with the use of the goods (ticket). The goods purchaser 12 then pays the bill for the goods provider 10 (Step 25). In this case, the goods purchaser 12 sometimes pays collectively the sum of the money for the goods purchased within a predetermined term.

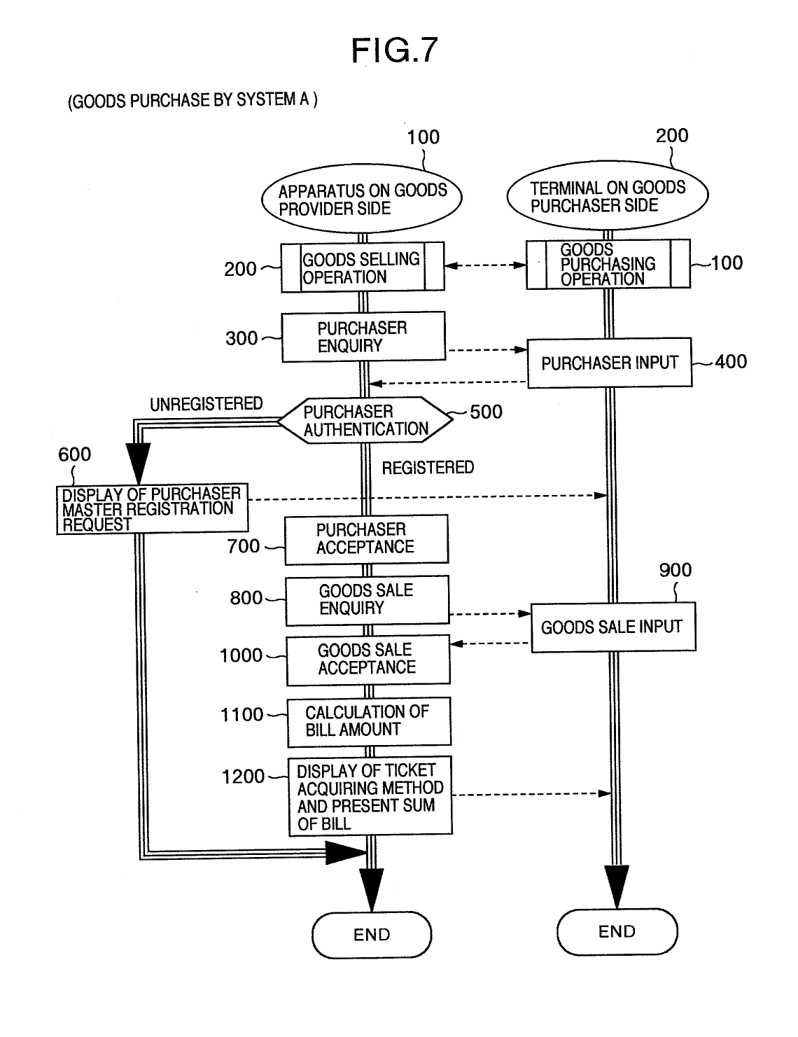

Next, the process between the apparatus 100 of the goods provider 10 and the terminal 200 of the goods purchaser 12 will be explained concretely. As shown in FIG. 7, the goods selling operation (Step 200) is made in accordance with the goods purchasing operation from the terminal 200 (Step 100). Next, the apparatus 100 enquires the goods purchaser to the terminal 200 (Step 300). Receiving this inquiry, the terminal 200 accepts the input of the goods purchaser ID, the point acquiring party, etc, and transmits the inputted data to the apparatus 100 (Step 400). The input screen displayed on the display of the terminal 200 at this time is the same as the one already shown in FIG. 6A. Receiving the data such as the goods purchaser ID, etc, the apparatus 100 executes authentication (retrieval of the database 140) of the goods purchaser 12. When the goods purchaser 12 is found unregistered in this authentication, the apparatus 100 transmits the data representing that the goods purchaser 12 be registered to the purchaser master to the terminal 200 (Step 600), and executes a registration processing. When the goods purchaser 12 is found registered in authentication, on the other hand, a predetermined acceptance processing is conducted (Step 700). A series of purchase accepting/selling process including inquiry of the goods, acceptance of its input, calculation of the bill amount, report of the sum and acquisition method of the goods (ticket) are executed (Steps 800→900→1000→1100→1200).

Next, the system C will be explained. The goods user 11 communicates with the apparatus 100 of the goods provider 10 through the terminal 300, makes the goods purchasing procedure and gives the instruction of the point acquiring party to the apparatus 100 of the goods provider 10 as shown in FIG. 5B (Step 30). In this instance, the display of the terminal 300 of the goods user 11 displays the screen for inputting the point acquiring party as shown in FIG. 6A, and the associated file in the database 140 inside the server 110 of the goods provider 10 is updated in the same way as in the system A. More concretely, a new goods sale record ID is generated to reflect this sale record, the point acquiring party identifier is allocated to the purchaser and the purchaser point acquiring party ID is set to the ID of the purchaser as in the goods sale record file shown in FIG. 2D. The bill file for each point acquiring party is updated and a new bill ID is generated in accordance with the purchaser point acquiring ID. Then, the bill ID, the bill reference number, the point acquiring party identifier, the purchaser point acquiring party ID, the user point acquiring party ID, the bill status, the bill amount, the bill date, the bill term, the payment date and the remarks are recorded.

Next, the goods purchaser 10 delivers the ticket received to the goods user 11 (Step 31) and the goods user 11 pays the advance (Step 32). When the goods user 11 uses the goods so purchased (Step 33), the point is actually given to the server 110 of the goods provider 10 receiving the notice (Step 34) and the database 140 is updated. In other words, in the goods utilization record file shown in FIG. 3A, the goods utilization record ID is generated, and the utilization record reference number, the utilization date, the goods sale record ID, the remarks, the inputting party and the inputting date are recorded to reflect the utilization record of the goods. In the point application record file shown in FIG. 3B, too, a new point application record ID is generated to reflect the point application record. The point application reference number, the goods utilization record ID, the application date, the point number, the point acquiring party identifier, the purchaser point acquiring party ID and the remarks are recorded. In the link for linking the goods sale record file and the point application record file in FIG. 3C, too, a new link ID is generated in accordance with the point application record ID and the predetermined data items such as the sale record ID are appropriately recorded. In this instance, the goods purchaser master file in FIG. 2B is retrieved to confirm whether or not the goods purchaser 12 is registered.

When the goods purchaser 12 is found registered, the display of the apparatus used for utilizing the ticket, for example, displays the notice that the point is practically given in accordance with the utilization of the goods (ticket). Then, the goods user 11 requests the goods purchaser 12 to settle the bill either by word or writing (Step 35). The goods purchaser 12 suitably connects with the apparatus 100 of the goods provider 10 and confirms the point application status and the utilization record through the terminal 300 (Step 36). The goods purchaser 12 pays the bill corresponding to the advance paid by the goods user 11 (Step 37).

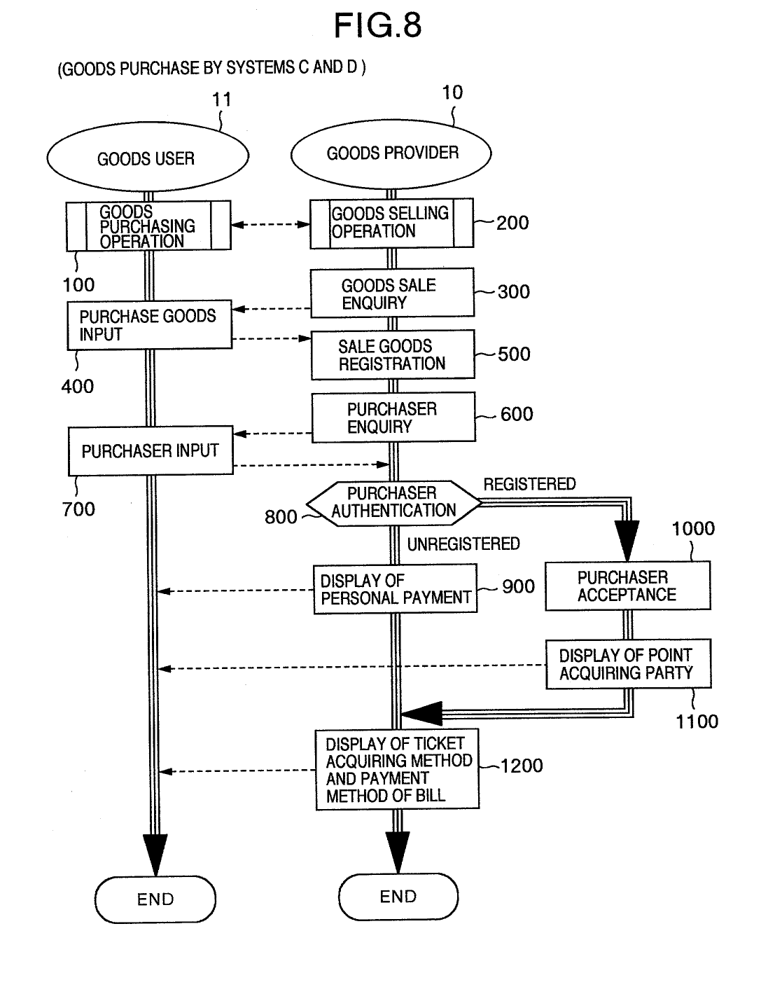

The process between the apparatus 100 of the goods provider 10 and the terminal 300 of the goods user 11 will be concretely explained. As shown in FIG. 8, the goods selling operation A (Step 200) is conducted in accordance with the goods purchasing operation A (Step 100) from the terminal 300. A series of operations from the enquiry of the goods to the acceptance of the input is executed (Steps 300→400→500). Next, the apparatus 100 enquires the terminal 300 of the goods purchaser (Step 600). Receiving this enquiry, the terminal 300 accepts the input of the goods purchaser ID, the point acquiring party, etc, and transmits them to the apparatus 100 (Step 700). Receiving the goods purchaser ID, etc, the apparatus 100 authenticates the goods purchaser 12 (retrieval of the database 140: Step 800). When the goods purchaser 12 is found unregistered in this authentication, the apparatus 100 transmits to the terminal 300 the condition that the payment be made by the goods user 11 by himself (Step 900). On the other hand, when the goods purchaser 12 is found registered, a predetermined acceptance processing for updating the database 140 stipulating that the point acquiring party is the goods purchaser 12, etc, is conducted (Step 1000). The display of the terminal 300 of the goods user 11 displays the screen for inputting the point acquiring party as shown in FIG. 6A, and the associated file in the database 140 inside the server 100 of the goods provider 10 is updated (Step 1100). The apparatus 100 transmits to the terminal 300 the data for displaying the acquiring method of the ticket as the goods and the payment method on the display (Step 1200).

Next, the system D will be explained. When the user as also the goods purchaser communicates with the apparatus 100 of the goods provider 10 through the terminal 300 as shown in FIG. 5C, the user makes the purchase procedure and gives the instruction of the point acquiring party to the apparatus 100 of the goods provider 10 (Step 40). In this instance, the display of the terminal 300 of the goods purchaser 12 displays the screen for inputting the point acquiring party as shown in FIG. 6A. The input screen includes the column 211 to which the registration number of the goods purchaser 12 (goods user 11) as the payer of the goods is inputted as the point acquiring party. Since the registration number as the goods user 11 is in advance registered, the goods user 11 clicks the cancel button 217 through the mouse and switches the registration screen to that of the goods user 11 so that the user himself becomes the point acquiring party. As the point acquiring party is thus designated and inputted, the associated file in the database 140 inside the server 110 of the goods provider 10 is updated. More specifically, a new goods user master ID and a user number are generated in the goods user master file, and the input of the user name, the company name and the telephone number is accepted and recorded. Recording of the sum of the points acquired so far and the remarks is also made, whenever necessary. Further, as shown in the goods sale record file in FIG. 2D, a new goods sale record ID is generated to reflect this sale record, the point application identifier is set to the user and the user point acquiring party ID is set to the ID of the user. The bill file for each point acquiring party is updated and a new bill ID is generated in accordance with the purchaser point acquiring party ID. Then, the bill ID, the bill reference number, the point acquiring party identifier, the purchaser point acquiring party ID, the user point acquiring party ID, the bill status, the bill amount, the bill date, the bill term, the payment date and the remarks are recorded.

Next, the airline ticket as the goods is provided to the goods user 11 as the goods purchaser 12 (Step 42) and after the ticket is practically used, the point is given (Steps 43→44). In this instance, the associated file in the database 140 inside the server 110 of the goods provider 10 is updated. More specifically, in the goods utilization record file in FIG. 3A, the goods utilization record ID is generated, and the utilization record reference number, the utilization date, the goods sale record ID, the remarks, the inputting party and the inputting date are recorded to reflect the utilization record of the goods. In the point application record file in FIG. 3B, too, a new point application record ID is generated to reflect the point application record. The point application reference number, the goods utilization ID, the application date, the point number, the point acquiring party identifier, the purchaser point acquiring ID and the remarks are recorded. In the link for linking the goods sale record file and the point application record file in FIG. 3C, too, a new link ID is generated in accordance with the point application record ID, and the predetermined data items such as the sale record ID, etc, are appropriately recorded. In this instance, the goods user master file in FIG. 2C is retrieved to confirm whether or not the goods user 11 is registered. When the goods user 11 is found registered in this instance, the display 620 provided to the check-in apparatus 20 used for checking the airline ticket displays the report that the point is practically given in accordance with the use of the goods (mileage card).

The concrete process between the apparatus 100 of the goods provider 10 and the terminal 300 of the goods user 11 is the same as that of the system C shown in FIG. 8, but is different in that the point acquiring party is the goods user 11 that is not registered in advance.

Next, the explanation will be given on the case where both goods purchaser 12 and goods user 11 are registered in advance. In this case, the systems A to D are conceivable. As to the systems A and C, however, they are the same as the afore-mentioned case where only the goods purchaser 12 is registered in advance and hence the explanation will be omitted to avoid repetition.

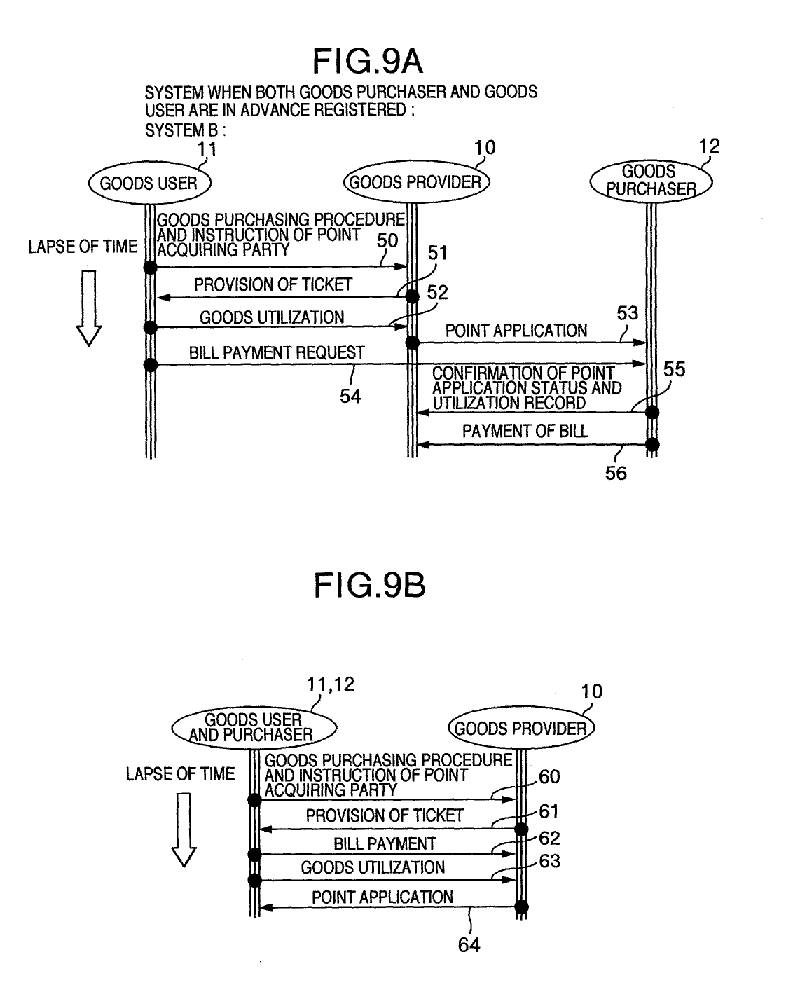

First, the explanation will be given on the system B. As shown in FIG. 9A, the goods user 11 communicates with the apparatus 100 of the goods provider 10 through the terminal 300, makes the goods purchasing procedure and gives the instruction of the point acquiring party to the apparatus 100 of the goods provider 10 (Step 50). In this instance, the display of the terminal 300 of the goods user 11 displays the screen for inputting the point acquiring party as shown in FIG. 6A, and the associated file in the database 140 inside the server 110 of the goods provider 10 is updated in the same way as in the system A. More specifically, in the goods sale record file in FIG. 2D, a new goods sale record ID is generated to reflect this sale record, the point acquiring party identifier is set to the purchaser and the purchaser point application ID is set to the ID of the purchaser. The bill file for each point acquiring party is updated and a new bill ID is generated in accordance with the purchaser point acquiring party ID. Then, the bill ID, the bill reference number, the point acquiring party identifier, the purchaser point acquiring point ID, the user point acquiring party ID, the bill status, the bill amount, the bill date, the bill term, the payment date and the remarks are recorded.

Next, the goods provider 10 provides the ticket to the goods user 11 (Step 51). The goods user 11 uses the goods (ticket: Step 52). The point is practically given to the server 110 of the goods provider 10 receiving the report (Step 53) and the database 140 is updated. More concretely, in the goods utilization record file shown in FIG. 3A, the goods utilization record ID is generated, and the utilization record reference number, the utilization date, the goods sale record ID, the remarks, the inputting party and the inputting date are recorded to reflect this utilization record of the goods. In the point application record file in FIG. 3B, too, a new point application record ID is generated to reflect the record of the point application, and the point application reference number, the goods utilization record ID, the application date, the point number, the point acquiring party identifier, the purchaser point acquiring party ID and the remarks are recorded. In the link for linking the goods sale record file and the point application record file in FIG. 3C, too, a new link ID is generated in accordance with the point application record ID, and the predetermined data items such as the sale record ID are appropriately recorded. In this case, the goods user master file shown in FIG. 2B is retrieved to confirm whether or not the goods user 11 is registered. When the goods user 11 is found registered, the display provided to the apparatus used for checking the ticket displays the report that the point is practically given in accordance with the utilization of the goods (ticket). The goods user 11 then requests the goods purchaser 12 to pay the bill either by word or writing (Step 54). Next, the goods purchaser 12 suitably communicates with the apparatus 100 of the goods provider 10 and confirms the own point application status and the utilization record through the terminal 300 (Step 55). The goods purchaser 12 pays the bill (Step 56).

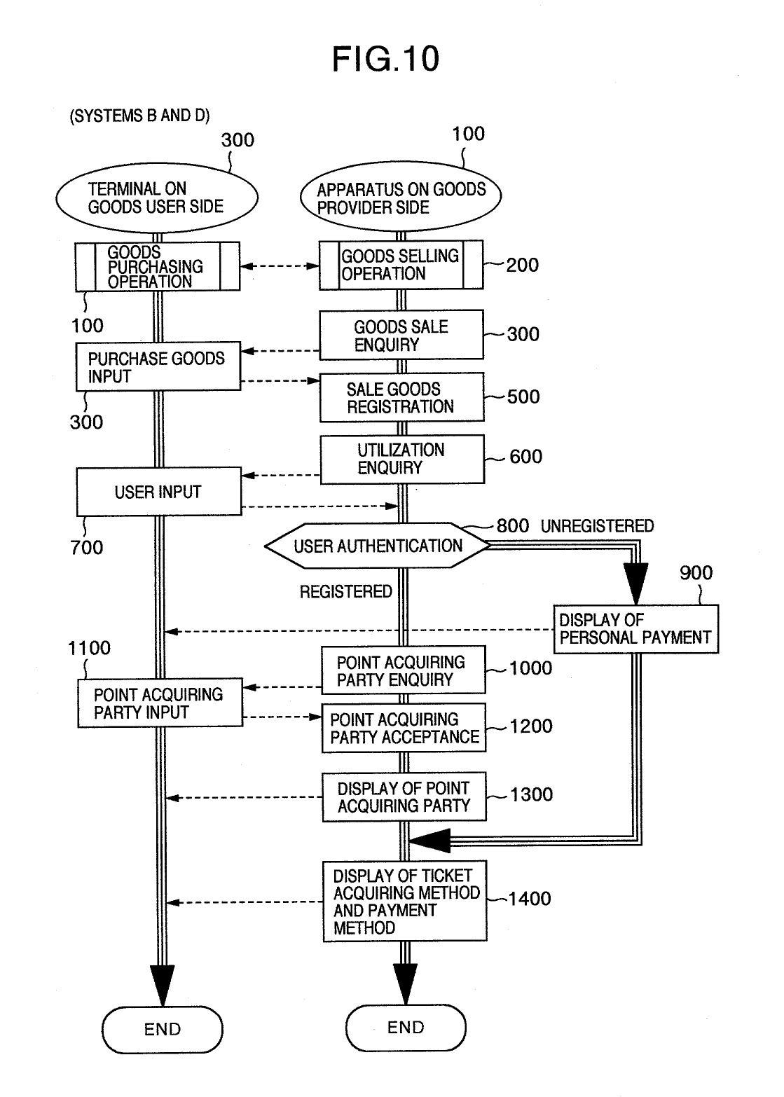

The process between the apparatus 100 of the goods provider 10 and the terminal 300 of the goods user 11 will be concretely explained. As shown in FIG. 10, the goods selling operation (Step 200) is conducted in accordance with the goods purchasing operation (Step 100) from the terminal 300. A series of operations from the enquiry of the goods sold to the acceptance of the input is executed (Steps 300→400→500). Receiving the enquiry, the terminal 300 accepts the input of the ID of the user of the goods, the point acquiring party, etc, and transmits them to the apparatus 100 (Step 700). Receiving the ID of the purchaser of the goods, etc, the apparatus authenticates the goods user 11 (retrieval of database 140: Step 800). When the goods user 11 is found unregistered in this authentication, the goods user 11 transmits the data representing, on the terminal 300, that the user himself pays the bill (Step 900). When the goods purchaser 12 is found registered in authentication, on the other hand, the apparatus 100 enquires the terminal 300 for the point acquiring party (Step 1000). The display of the terminal 300 displays the screen for inputting the point acquiring party as shown in FIG. 6A, and the associated file in the database 140 inside the server 110 of the goods provider 10 is updated in the same way as in the system A described already (Steps 1100→1200). When the point acquiring party is inputted through the terminal 300, this inputting operation designates whether the party that is the point acquiring party and pays the bill is the goods purchaser 12 or the goods user 11. In the system B, the goods purchaser 12 is designated. The apparatus 100 then transmits the data so that the point acquiring party so accepted can be displayed on the display of the terminal 300 (Step 1300). The apparatus 100 then transmits the data so that the acquiring method of the ticket as the goods and the payment method can be displayed on the terminal (Step 1400). Incidentally, various authentication methods such as a password, an ID card, a fingerprint, and so forth, can be employed to authenticate the purchaser and the user in the process shown in FIG. 10.

Next, the system D will be explained. As shown in FIG. 9B, the user as the purchaser of the goods communicates with the apparatus 100 of the goods provider 10 through the terminal 300, makes the goods purchasing procedure and gives the instruction of the point acquiring party to the apparatus 100 of the goods provider 10 (Step 60). At this time, the display of the terminal 300 of the goods purchaser 12 displays the screen for inputting the point acquiring party as shown in FIG. 6A. The input screen includes the column 211 to which the registration number of the goods purchaser 12 or the goods user 11 is inputted as the point acquiring party. When the point acquiring party is designated and inputted, the associated file in the database 140 inside the server 110 of the goods provider 10 is updated. More concretely, in the goods user master file in FIG. 2C, the input of the goods user master ID is accepted, and the user number, the user name, the company and the telephone number are recorded. The remarks are also recorded appropriately. As shown in the goods sale record file in FIG. 2D, a new goods sale record ID is generated to reflect the sale record. The point application identifier is set to the user and the user point acquiring party ID is set to the ID of the user. The bill file for each point acquiring party is updated and a new bill ID is generated in accordance with the purchaser point acquiring party ID. Then, the bill ID, the bill reference number, the point acquiring party identifier, the purchaser point acquiring party ID, the user point acquiring party ID, the bill status, the bill amount, the bill date, the bill term, the payment date and the remarks are recorded.

Next, the airline ticket as the goods is provided to the goods purchaser 12 (Step 61). The goods purchaser 12 delivers the ticket received to the goods user 11. The goods user 11 pays the bill (Step 62) and the point is given when the user practically uses the ticket (Steps 63→64). In this case, as shown in FIG. 6B, the display provided to the apparatus used for utilizing the ticket displays that the point is practically given in accordance with the utilization of the goods (mileage card). The associated file in the database 140 inside the server 110 of the goods provider 10 is updated. More concretely, in the goods utilization record file in FIG. 3A, the goods utilization record ID is generated, and the utilization record reference number, the utilization date, the goods sale record ID, the remarks, the inputting party and the inputting date are recorded to reflect the utilization record of the goods. In the point application record file in FIG. 3B, too, a new point application ID is generated to reflect the point application record. Then, the point application reference number, the goods utilization record ID, the application date, the point number, the point acquiring party identifier, the purchaser point acquiring party ID and the remarks are recorded. In the link for linking the goods sale record file to the point application record file in FIG. 3C, further, a new link ID is generated in accordance with the point application record ID, and the predetermined data items such as the sale record ID are appropriately recorded. In this case, the goods user master file in FIG. 2C is retrieved to confirm whether or not the goods user 11 is registered.

The concrete process between the apparatus 100 of the goods provider 10 and the terminal 300 of the goods user 11 is the same as that of the aforementioned system B as shown in FIG. 10. However, the point acquiring party is the goods user (payer of the bill).

Incidentally, in the systems A to D, the designation input of the point acquiring party may be conducted by displaying a table of the registration numbers on the screen and allowing the operator to select the registration number from the table through the input unit such as the mouse or the keyboard, besides the direct input of the registration number to the column 221 shown in FIG. 6A.

According to the point management technology described above, the point such as mileage of the airline ticket used by an employee on a business trip is given to the company as the payer of the bill. Therefore, the expenses in the company can be reduced in accordance with utilization frequency of the airline tickets. Further, this technology motivates the company to utilize goods and services offering the frequent customer point services and results in repeated orders of the payer of the bill.

The point is given to the payers of the bills for the goods and the services. Therefore, it is possible to prevent the point from being given to the person who does not pay the bill but merely enjoy the goods or services, and the benefit of the point is given to the payer of the bill who should originally enjoy the point.

It should be further understood by those skilled in the art that the foregoing description has been made on embodiments of the invention and that various changes and modifications may be made in the invention without departing from the spirit of the invention and the scope of the appended claims.

1. A frequent customer point management method for giving frequent customer points to customers inclusive of purchasers and users of goods connected through a predetermined network, using an information processing system including bill payer information storage means for storing information of a payer of a bill of goods and point information storage means for storing information of application of a point corresponding to said goods, said method comprising the steps of:
receiving bill payer information stipulating a payer of a bill of said goods from said customer and retrieving said bill payer information storage means on the basis of said bill payer information; and
updating said point information storage means to stipulate said bill payer as an acquiring party of said point corresponding to said goods when said bill payer is registered to said bill payer information storage means.

2. A frequent customer point management method according to claim 1, wherein information for designating said point acquiring party is received as said bill payer information from said goods purchaser or from said goods user through said network when said bill payer information is received.

3. A frequent customer point management method according to claim 1, wherein said bill payer information is received from said goods purchaser or said goods user simultaneously with ordering of said goods through said network.

4. A frequent customer point management method according to claim 1, wherein said point information storage means is updated and said point is given to said bill payer when said goods is utilized after said point information storage means is updated to stipulate said bill payer as said point acquiring party.

5. A frequent customer point management method according to claim 1, wherein said bill payer is either said goods purchaser or said goods user, and said bill payer information is received from said goods purchaser or from said goods user through said network.

6. A frequent customer point management method according to claim 1, wherein a transmission request of information of said bill payer is transmitted to said goods purchaser and to said good user when said bill payer is found unregistered to said bill payer information storage means as a result of retrieval of said bill payer information storage means, and said bill payer information transmitted from said goods payer or from said goods user is received and is registered to said bill payer information storage means.

7. A frequent customer point management method according to claim 1, wherein an amount of the bill paid is reported to a terminal used by said bill payer.

8. A point management system for use in a frequent customer point management method for giving frequent customer points corresponding to use of goods from a goods provider to customers inclusive of purchasers and users of goods connected through a predetermined network, including at least bill payer information storage means for storing information of a payer of a bill of goods and point information storage means for storing information of application of a point corresponding to said goods, said system comprising:
means for receiving bill payer information stipulating a payer of a bill of said goods;
means for retrieving said bill payer information storage means on the basis of said bill payer information received; and
means for updating said point information storage means to stipulate said bill payer as an acquiring party of said point corresponding to said goods when said bill payer is registered to said bill payer information storage means.

9. A point management system according to claim 8, wherein information for designating said point acquiring party is received as said bill payer information from said goods purchaser or from said goods user through said network.

10. A point management system according to claim 8, wherein said bill payer information is received from said goods purchaser or said goods user simultaneously with ordering of said goods through said network.

11. A point management system according to claim 8, wherein said point information storage means is updated and said point is given to said bill payer when said goods is utilized after said point information storage means is updated to stipulate said bill payer as said point acquiring party.

12. A frequent customer point management method for giving frequent customer points to customers inclusive of purchasers and users of goods, said method comprising the steps of:
receiving bill payer information stipulating a payer of a bill of said goods from said customer and retrieving bill payer information storage means for storing information of a payer of a bill of goods on the basis of said bill payer information; and
updating point information storage means for storing information of application of a point corresponding to said goods to stipulate said bill payer as an acquiring party of said point corresponding to said goods when said bill payer is registered to said bill payer information storage means.

13. A point management system for use in a frequent customer point management method for giving frequent customer points corresponding to use of goods from a goods provider to customers inclusive of purchasers and users of goods, said system comprising:
means for receiving bill payer information stipulating a payer of a bill of said goods;
means for retrieving bill payer information storage means for storing information of a payer of a bill of goods on the basis of said bill payer information received; and
means for updating point information storage means for storing information of application of a point corresponding to said goods to stipulate said bill payer as an acquiring party of said point corresponding to said goods when said bill payer is registered to said bill payer information storage means.
